(19) United States
(12) Patent Application Publication
(10) Pub. No.: US 2025/0218109 A1
(43) Pub. Date: Jul. 3, 2025

(54) Rendering Videos with Novel Views from Near-Duplicate Photos

(71) Applicant: Google LLC, Mountain View, CA (US)

(72) Inventors: Janne Matias Kontkanen, San Francisco, CA (US); Zhengqi Li, Jersey City, NJ (US); David Salesin, Sausalito, CA (US); Keith Noah Snavely, New York City, NY (US); Brian L. Curless, Seattle, WA (US); Qianqian Wang, New York City, NY (US)

(21) Appl. No.: 18/850,824

(22) PCT Filed: Apr. 19, 2023
(86) PCT No.: PCT/US2023/019089

§ 371 Date: Sep. 25, 2024

Related U.S. Application Data
(60) Provisional application No. 63/335,486, filed on Apr. 27, 2022.

(51) Int. Cl. G06T 15/20; G06T 7/246; G06T 13/20; G06T 15/04

(52) U.S. Cl. CPC G06T 15/205; G06T 7/248; G06T 13/20; G06T 15/04; G06T 2207/10016; G06T 2207/10024; G06T 2207/10028; G06T 2207/20084; G06T 2210/56

(57) ABSTRACT

The technology introduces 3D Moments, a new computational photography effect. As input a pair of near-duplicate photos is taken (FIG. 1A), i.e., photos of moving subjects from similar viewpoints, which may be very common in people's photo collections. As output, the system produces a video that smoothly interpolates the scene motion from the first photo to the second, while also producing camera motion with parallax that gives a heightened sense of 3D (FIG. 1B). To achieve this effect, the scene is represented as a pair of feature-based layered depth images augmented with scene flow (306). This representation enables motion interpolation along with independent control of the camera viewpoint. The system produces photorealistic space-time videos with motion parallax and scene dynamics (322), while plausibly recovering regions occluded in the original views. Experimentation demonstrating superior performance over baselines on public benchmarks and in-the-wild photos.

### CROSS-REFERENCE TO RELATED APPLICATIONS

The present application claims the benefit of and priority to U.S. Provisional Application No. 63/335,486, filed Apr. 27, 2022, the entire disclosure of which is incorporated herein by reference.

### BACKGROUND

Digital photography enables users to take scores of photos in order to capture just the right moment. In fact, people often end up with many near-duplicate photos in their image collections as they try to capture the best facial expression of a family member, or the most memorable part of an action. These near-duplicate photos often end up just lying around in digital storage, unviewed. This consumes storage space and can make the process of locating desirable imagery unnecessarily time consuming.

### BRIEF SUMMARY

The technology utilizes near-duplicate photos to create a compelling new kind of 3D photo enlivened with animation. This new effect is referred to herein as “3D Moments”. Given a pair of near-duplicate photos depicting a dynamic scene from nearby (perhaps indistinguishable) viewpoints, such as the pair of images in FIG. 1A, a goal is to simultaneously enable cinematic camera motion with 3D parallax and faithfully interpolate scene motion to synthesize short space-time videos like the one depicted in FIG. 1B. 3D Moments combine both camera and scene motion in a compelling way, but involve very challenging vision problems. For instance, the system should jointly infer 3D geometry, scene dynamics, and content that becomes newly disoccluded during the animation. People often take many near-duplicate photos in an attempt to capture the perfect expression. Thus, given a pair of these photos, e.g., taken with a hand-held camera from nearby viewpoints (see FIG. 1A), the approach discussed herein brings these photos to life as 3D Moments, producing space-time videos with cinematic camera motions and interpolated scene motion (see FIG. 1B).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-B illustrate an example where a pair of input images is used to produce a space-time video in accordance with aspects of the technology.

FIG. 2 illustrates a Transformer-type architecture for use in accordance with aspects of the technology.

FIGS. 3A-C illustrate features, modules and methods in accordance with aspects of the technology.

FIG. 4 illustrates an example of agglomerative clustering in disparity space in accordance with aspects of the technology.

FIGS. 5A-B illustrates tables of test results in accordance with aspects of the technology.

FIGS. 6A-B illustrate a first qualitative comparison in accordance with aspects of the technology.

FIGS. 7A-B illustrate a second qualitative comparison in accordance with aspects of the technology.

FIGS. 8A-B illustrate a third qualitative comparison in accordance with aspects of the technology.

FIGS. 9A-D illustrate qualitative comparisons on in-the-wild photos in accordance with aspects of the technology.

FIGS. 10A-B illustrate a system for use with aspects of the technology.

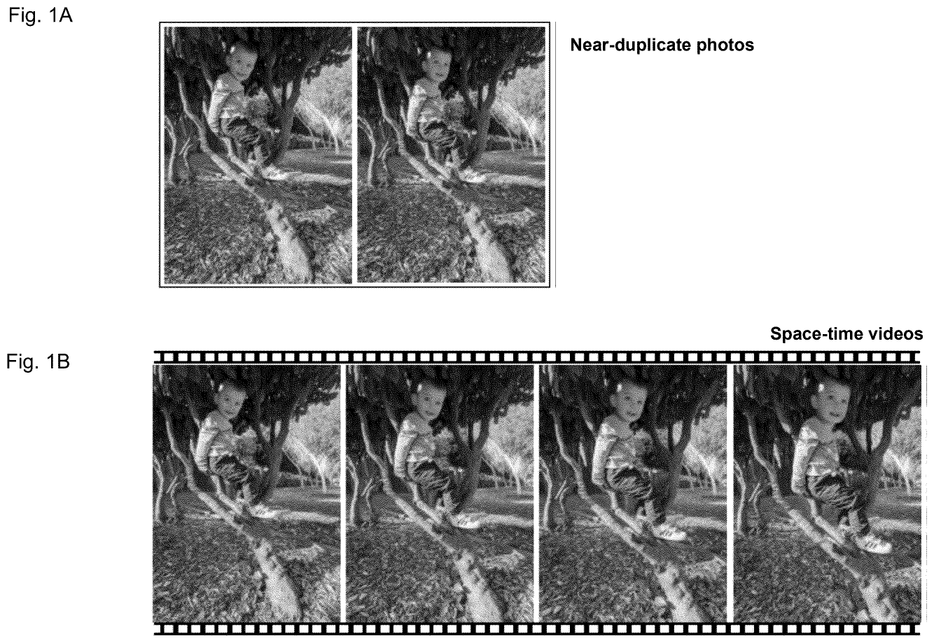

### DETAILED DESCRIPTION

### Overview

While there are various image processing techniques that involve inferring 3D geometry, evaluating scene dynamics, and addressing disocclusion, tackling such issues jointly is non-trivial, especially with image pairs with unknown camera poses as input.

For instance, certain view synthesis methods for dynamic scenes may require images with known camera poses. Single-photo view synthesis methods can create animated camera paths from a single photo, but cannot represent moving people or objects. Frame interpolation can create smooth animations from image pairs, but only in 2D. Furthermore, naively applying view synthesis and frame interpolation methods sequentially can result in temporally inconsistent, unrealistic animations.

To address these challenges, the approach for creating 3D Moments involves explicitly modeling time-varying geometry and appearance from two uncalibrated, near-duplicate photos. This involves representing the scene as a pair of feature-based layered depth images (LDIs) augmented with scene flows. This representation is built by first transforming the input photos into a pair of color LDIs, with inpainted color and depth for occluded regions. Features are then extracted for each layer with a neural network to create the feature LDIs. In addition, optical flow is computed between the input images and combined with the depth layers to estimate scene flow between the LDIs. To render a novel view at a novel time, the constructed feature LDIs are lifted into a pair of 3D point clouds. A depth-aware, bidirectional splatting and rendering module is employed that combines the splatted features from both directions.

Thus, aspects of the technology involve the task of creating 3D Moments from near-duplicate photos of dynamic scenes, and creating a new representation based on feature LDIs augmented with scene flows, and a model that can be trained for creating 3D Moments. The model may employ, by way of example, a Transformer-type architecture, a convolutional neural network (CNN), recurrent neural network (RNN), long short-term memory (LSTM) network or combination thereof.

This approach has been tested on both multi-view dynamic scene benchmarks and in-the-wild photos in terms of rendering quality, and demonstrate superior performance compared to state-of-the-art baselines.

### General Transformer Approach

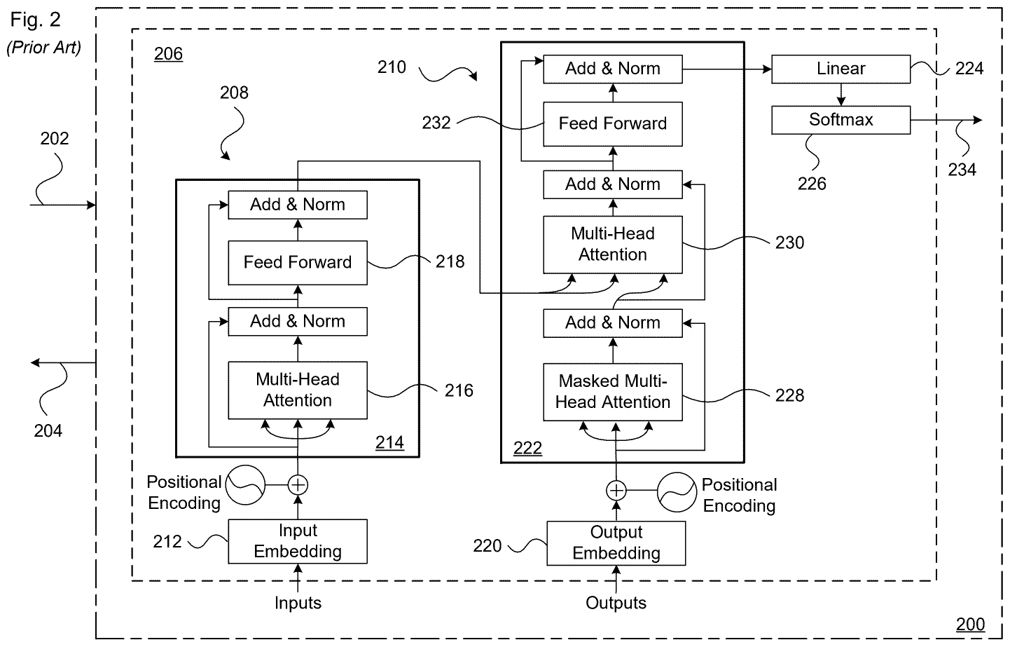

One approach that can be used with certain aspects of the model (e.g., monocular depth estimation) employs a self-attention architecture, e.g., the Transformer neural network encoder-decoder architecture. An exemplary general Transformer-type architecture is shown in FIG. 2, which is based on the arrangement shown in U.S. Pat. No. 10,452,978, entitled “Attention-based sequence transduction neural networks”, the entire disclosure of which is incorporated herein by reference.

System 200 of FIG. 2 is implementable as computer programs by processors of one or more computers in one or more locations. The system 200 receives an input sequence 202 and processes the input sequence 202 to transduce the input sequence 202 into an output sequence 204. The input sequence 202 has a respective network input at each of multiple input positions in an input order and the output sequence 204 has a respective network output at each of multiple output positions in an output order.

System 200 can perform any of a variety of tasks that require processing sequential inputs to generate sequential outputs. System 200 includes an attention-based sequence transduction neural network 206, which in turn includes an encoder neural network 208 and a decoder neural network 210. The encoder neural network 208 is configured to receive the input sequence 202 and generate a respective encoded representation of each of the network inputs in the input sequence. An encoded representation is a vector or other ordered collection of numeric values. The decoder neural network 210 is then configured to use the encoded representations of the network inputs to generate the output sequence 204. Generally, both the encoder 208 and the decoder 210 are attention-based. In some cases, neither the encoder nor the decoder includes any convolutional layers or any recurrent layers. The encoder neural network 208 includes an embedding layer (input embedding) 212 and a sequence of one or more encoder subnetworks 214. The encoder neural 208 network may N encoder subnetworks 214.

The embedding layer 212 is configured, for each network input in the input sequence, to map the network input to a numeric representation of the network input in an embedding space, e.g., into a vector in the embedding space. The embedding layer 212 then provides the numeric representations of the network inputs to the first subnetwork in the sequence of encoder subnetworks 214. The embedding layer 212 may be configured to map each network input to an embedded representation of the network input and then combine, e.g., sum or average, the embedded representation of the network input with a positional embedding of the input position of the network input in the input order to generate a combined embedded representation of the network input. In some cases, the positional embeddings are learned. As used herein, “learned” means that an operation or a value has been adjusted during the training of the sequence transduction neural network 206. In other cases, the positional embeddings may be fixed and are different for each position.

The combined embedded representation is then used as the numeric representation of the network input. Each of the encoder subnetworks 214 is configured to receive a respective encoder subnetwork input for each of the plurality of input positions and to generate a respective subnetwork output for each of the plurality of input positions. The encoder subnetwork outputs generated by the last encoder subnetwork in the sequence are then used as the encoded representations of the network inputs. For the first encoder subnetwork in the sequence, the encoder subnetwork input is the numeric representations generated by the embedding layer 212, and, for each encoder subnetwork other than the first encoder subnetwork in the sequence, the encoder subnetwork input is the encoder subnetwork output of the preceding encoder subnetwork in the sequence.

Each encoder subnetwork 214 includes an encoder self-attention sub-layer 216. The encoder self-attention sub-layer 216 is configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism as shown. In some implementations, each of the encoder subnetworks 214 may also include a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 2.

Some or all of the encoder subnetworks can also include a position-wise feed-forward layer 218 that is configured to operate on each position in the input sequence separately. In particular, for each input position, the feed-forward layer 218 is configured receive an input at the input position and apply a sequence of transformations to the input at the input position to generate an output for the input position. The inputs received by the position-wise feed-forward layer 218 can be the outputs of the layer normalization layer when the residual and layer normalization layers are included or the outputs of the encoder self-attention sub-layer 216 when the residual and layer normalization layers are not included. The transformations applied by the layer 218 will generally be the same for each input position (but different feed-forward layers in different subnetworks may apply different transformations).

In cases where an encoder subnetwork 214 includes a position-wise feed-forward layer 218 as shown, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. As noted above, these two layers are also collectively referred to as an “Add & Norm” operation. The outputs of this layer normalization layer can then be used as the outputs of the encoder subnetwork 214.

Once the encoder neural network 208 has generated the encoded representations, the decoder neural network 210 is configured to generate the output sequence in an auto-regressive manner. That is, the decoder neural network 210 generates the output sequence, by at each of a plurality of generation time steps, generating a network output for a corresponding output position conditioned on (i) the encoded representations and (ii) network outputs at output positions preceding the output position in the output order. In particular, for a given output position, the decoder neural network generates an output that defines a probability distribution over possible network outputs at the given output position. The decoder neural network can then select a network output for the output position by sampling from the probability distribution or by selecting the network output with the highest probability.

Because the decoder neural network 210 is auto-regressive, at each generation time step, the decoder network 210 operates on the network outputs that have already been generated before the generation time step, i.e., the network outputs at output positions preceding the corresponding output position in the output order. In some implementations, to ensure this is the case during both inference and training, at each generation time step the decoder neural network 210 shifts the already generated network outputs right by one output order position (i.e., introduces a one position offset into the already generated network output sequence) and (as will be described in more detail below) masks certain operations so that positions can only attend to positions up to and including that position in the output sequence (and not subsequent positions). While the remainder of the description below describes that, when generating a given output at a given output position, various components of the decoder 210 operate on data at output positions preceding the given output positions (and not on data at any other output positions), it will be understood that this type of conditioning can be effectively implemented using shifting.

The decoder neural network 210 includes an embedding layer (output embedding) 220, a sequence of decoder subnetworks 222, a linear layer 224, and a softmax layer 226. In particular, the decoder neural network can include N decoder subnetworks 222. However, while the example of FIG. 2 shows the encoder 208 and the decoder 210 including the same number of subnetworks, in some cases the encoder 208 and the decoder 210 include different numbers of subnetworks. The embedding layer 220 is configured to, at each generation time step, for each network output at an output position that precedes the current output position in the output order, map the network output to a numeric representation of the network output in the embedding space. The embedding layer 220 then provides the numeric representations of the network outputs to the first subnetwork 222 in the sequence of decoder subnetworks.

In some implementations, the embedding layer 220 is configured to map each network output to an embedded representation of the network output and combine the embedded representation of the network output with a positional embedding of the output position of the network output in the output order to generate a combined embedded representation of the network output. The combined embedded representation is then used as the numeric representation of the network output. The embedding layer 220 generates the combined embedded representation in the same manner as described above with reference to the embedding layer 212.

Each decoder subnetwork 222 is configured to, at each generation time step, receive a respective decoder subnetwork input for each of the plurality of output positions preceding the corresponding output position and to generate a respective decoder subnetwork output for each of the plurality of output positions preceding the corresponding output position (or equivalently, when the output sequence has been shifted right, each network output at a position up to and including the current output position). In particular, each decoder subnetwork 222 includes two different attention sub-layers: a decoder self-attention sub-layer 228 and an encoder-decoder attention sub-layer 230. Each decoder self-attention sub-layer 228 is configured to, at each generation time step, receive an input for each output position preceding the corresponding output position and, for each of the particular output positions, apply an attention mechanism over the inputs at the output positions preceding the corresponding position using one or more queries derived from the input at the particular output position to generate a updated representation for the particular output position. That is, the decoder self-attention sub-layer 228 applies an attention mechanism that is masked so that it does not attend over or otherwise process any data that is not at a position preceding the current output position in the output sequence.

Each encoder-decoder attention sub-layer 230, on the other hand, is configured to, at each generation time step, receive an input for each output position preceding the corresponding output position and, for each of the output positions, apply an attention mechanism over the encoded representations at the input positions using one or more queries derived from the input for the output position to generate an updated representation for the output position. Thus, the encoder-decoder attention sub-layer 230 applies attention over encoded representations while the decoder self-attention sub-layer 228 applies attention over inputs at output positions.

In the example of FIG. 2, the decoder self-attention sub-layer 228 is shown as being before the encoder-decoder attention sub-layer in the processing order within the decoder subnetwork 222. In other examples, however, the decoder self-attention sub-layer 228 may be after the encoder-decoder attention sub-layer 230 in the processing order within the decoder subnetwork 222 or different subnetworks may have different processing orders. In some implementations, each decoder subnetwork 222 includes, after the decoder self-attention sub-layer 228, after the encoder-decoder attention sub-layer 230, or after each of the two sub-layers, a residual connection layer that combines the outputs of the attention sub-layer with the inputs to the attention sub-layer to generate a residual output and a layer normalization layer that applies layer normalization to the residual output. These two layers being inserted after each of the two sub-layers, both referred to as an “Add & Norm” operation.

Some or all of the decoder subnetwork 222 also include a position-wise feed-forward layer 232 that is configured to operate in a similar manner as the position-wise feed-forward layer 218 from the encoder 208. In particular, the layer 232 is configured to, at each generation time step: for each output position preceding the corresponding output position: receive an input at the output position, and apply a sequence of transformations to the input at the output position to generate an output for the output position. The inputs received by the position-wise feed-forward layer 232 can be the outputs of the layer normalization layer (following the last attention sub-layer in the subnetwork 222) when the residual and layer normalization layers are included or the outputs of the last attention sub-layer in the subnetwork 222 when the residual and layer normalization layers are not included. In cases where a decoder subnetwork 222 includes a position-wise feed-forward layer 232, the decoder subnetwork can also include a residual connection layer that combines the outputs of the position-wise feed-forward layer with the inputs to the position-wise feed-forward layer to generate a decoder position-wise residual output and a layer normalization layer that applies layer normalization to the decoder position-wise residual output. These two layers are also collectively referred to as an “Add & Norm” operation. The outputs of this layer normalization layer can then be used as the outputs of the decoder subnetwork 222. At each generation time step, the linear layer 224 applies a learned linear transformation to the output of the last decoder subnetwork 222 in order to project the output of the last decoder subnetwork 222 into the appropriate space for processing by the softmax layer 226. The softmax layer 226 then applies a softmax function over the outputs of the linear layer 224 to generate the probability distribution (output probabilities) 234 over the possible network outputs at the generation time step. The decoder 210 can then select a network output from the possible network outputs using the probability distribution.

### Overall Architecture

The input to the system is a pair of images (I₀, I₁) of a dynamic scene taken at nearby times and camera viewpoints. By way of example, the nearby times may be within a few seconds (e.g., 2-5 seconds). For tractable motion interpolation, it may be assumed that motion between I₀ and I₁ is roughly within the operating range of a modern optical flow estimator. Here, this may be on the order of 25-50 pixels in one example, or no more than 75-100 pixels in another example.

A goal is to create 3D Moments by simultaneously synthesizing novel viewpoints and interpolating scene motions to render arbitrary intermediate times t ∈ [0, 1]. The output is a space-time vidco with cinematic camera motions and interpolated scene motion.

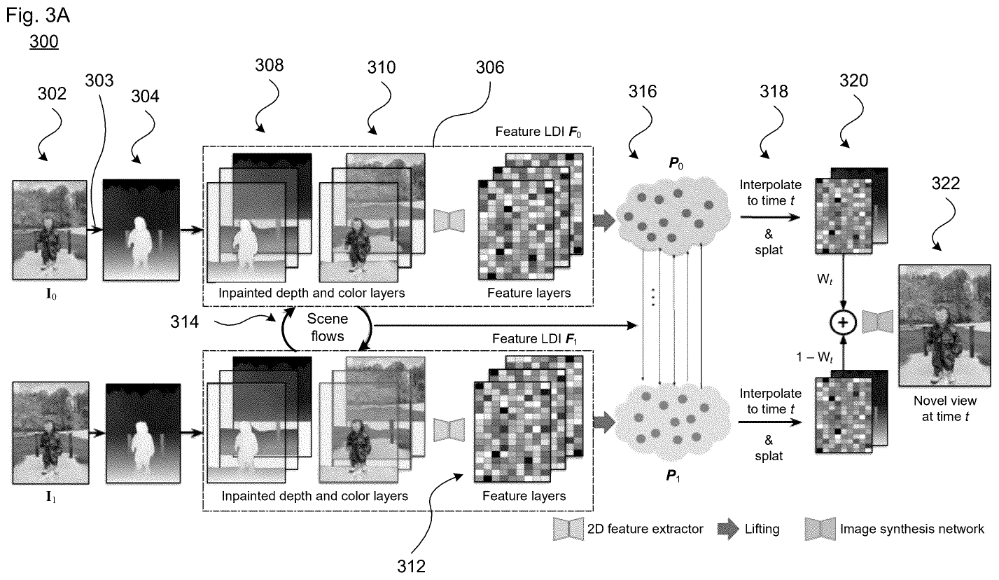

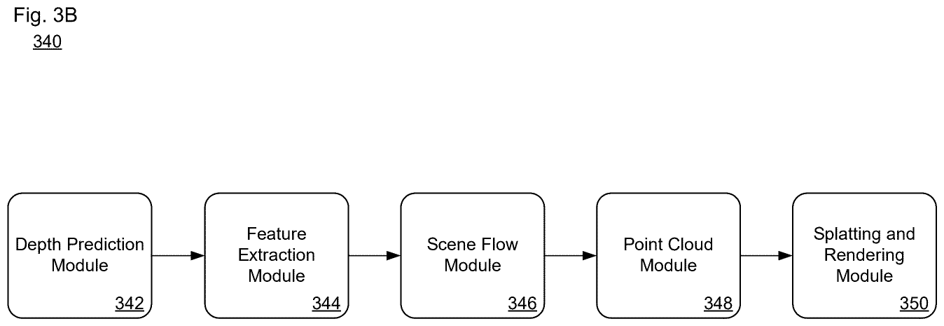

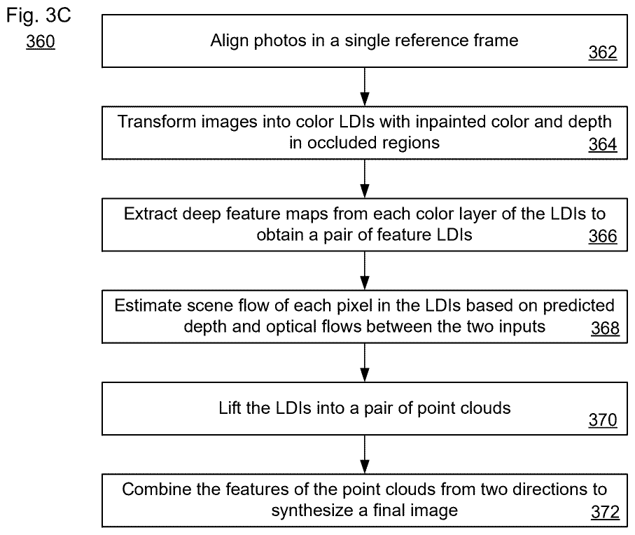

To this end, a framework is provided that enables efficient and photorealistic space-time novel view synthesis without the need for test-time optimization. An example 300 of a pipeline is illustrated in FIG. 3A. The system starts by aligning the two photos (e.g., RGBD images at 302) into a single reference frame via a homography (at 304), with monocular depth estimation occurring at 303. The depth (D) channel can be obtained, for example, by the Transformer architecture-based depth predictor described above and shown in FIG. 2. By way of example, an RGBD image is a combination of a color RGB image and a corresponding depth image, which is an image channel in which each pixel relates to the distance between an image plane and a corresponding object in the image. In particular, for two near-duplicate photos (I₀, I₁), the system aligns them with a homography and computes their dense depth maps. Each (RGBD) image is then converted to a color LDI (at 306), with the depth and color in occluded regions filled by depth-aware inpainting (at 308 and 310, respectively).

Feature LDIs are constructed from each of the inputs 308 and 310, where each pixel in the feature LDI is composed of its depth, scene flow and a learnable feature. To do so, the system first transforms each input image into a color LDI with inpainted color and depth in occluded regions. Deep feature maps are extracted from each color layer of these LDIs to obtain a pair of feature LDIs ( [symbol] ₀, [symbol] ₁) (at 312). For instance, a 2D feature extractor is applied to each color layer of the inpainted LDIs to obtain feature layers, resulting in feature LDIs ( [symbol] ₀, [symbol] ₁) associated with each of the input near-duplicate photos, where colors in the inpainted LDIs have been replaced with features.

To model scene dynamics (e.g., motion), the scene flows (314) of each pixel in the LDIs are estimated based on predicted depth and optical flows between the two inputs (the input images I₀, I₁).

To render a novel view at an intermediate time t (taken between the times t₀ associated with I₀ and t₁ associated with I₁), the feature LDIs are lifted into a pair of point clouds (P₀, P₁) (at 316). Via interpolation (at 318) the features are combined in two directions to synthesize the final image, by bidirectionally moving points along their scene flows to time t. Here, using a scene-flow-based bidirectional splatting and rendering module, the system then projects and splats these 3D feature points (at 320) into forward and backward feature maps (from P₀ and P₁, respectively) and corresponding projected depth maps, linearly blending them with weight map Wt derived from spatio-temporal cues, and passing the result into an image synthesis network to produce the final image (at 322).

FIG. 3B illustrates an example 340 of modules implemented by a computing system to perform the above-identified features. These include a depth prediction module 342, a feature extraction module 344, a scene flow module 346, a point cloud module 348, and a splatting and rendering module 350. FIG. 3C illustrates an example process 360 associated with these modules. This includes aligning the pair of photos in a single reference frame at block 362, transforming images into color LDIs with inpainted color and depth in occluded regions at block 364, extracting deep feature maps from each color layer of the LDIs to obtain a pair of feature LDIs at block 366, estimating scene flow of each pixel in the LDIs based on predicted depth and optical flows between the two inputs at block 368, lifting the LDIs into a pair of point clouds at block 370, and combining the features of the point clouds from two directions to synthesize a final image at block 372.

LDIs from Near-Duplicate Imagery/Photos

According to one aspect, the method first computes the underlying 3D scene geometry. As near-duplicates typically have scene dynamics and very little camera motion, standard Structure from Motion (SfM) and stereo reconstruction methods can produce unreliable results. Instead, it has been found that state-of-the-art monocular depth estimator “DPT” can produce sharp and plausible dense depth maps for images in the wild. Therefore, in one scenario the system relies on DPT to obtain the geometry for each image. DPT has been described by Ranftl et al, in “Vision transformers for dense prediction”, in ICCV, 2021, the entire disclosure of which is incorporated herein by reference.

To account for small camera pose changes between the views, the optical flow between the views may be computed using RAFT. RAFT has been described by Zachary Teed and Jia Deng in “Raft: Recurrent all-pairs field transforms for optical flow”, In ECCV, pages 402-419, Springer, 2020, the entire disclosure of which is incorporated herein by reference. The process may also estimate a homography between the images using the flow, and then warps I₁ to align with I₀.

Because it is only needed to align the static background of two images, regions with large optical flow above a threshold can be masked out, where those regions often correspond to moving objects. The system computes the homography using the remaining mutual correspondences given by the flow. Once I₁ is warped to align with I₀, their camera poses can be treated as identical. To simplify notation, I₀ and I₁ are also referenced here to denote the aligned input images.

The system then applies DPT to predict the depth maps for each image, such as described by Ranftl et al, in “Towards robust monocular depth estimation: Mixing datasets for zero-shot cross-dataset transfer”, IEEE TPAMI, 2020, the entire disclosure of which is incorporated herein by reference. To align the depth range of I₁ with I₀, a global scale is estimated and shifted for I₁'s disparities (here, 1/depth), using flow correspondences in the static regions. Next, the aligned photos and their dense depths are converted to an LDI representation, in which layers are separated according to depth discontinuities, and apply RGBD inpainting in occluded regions as described below. An example conversion approach is described by Shade et al. in “Layered depth images” in SIGGRAPH, 1998, the entire disclosure of which is incorporated herein by reference.

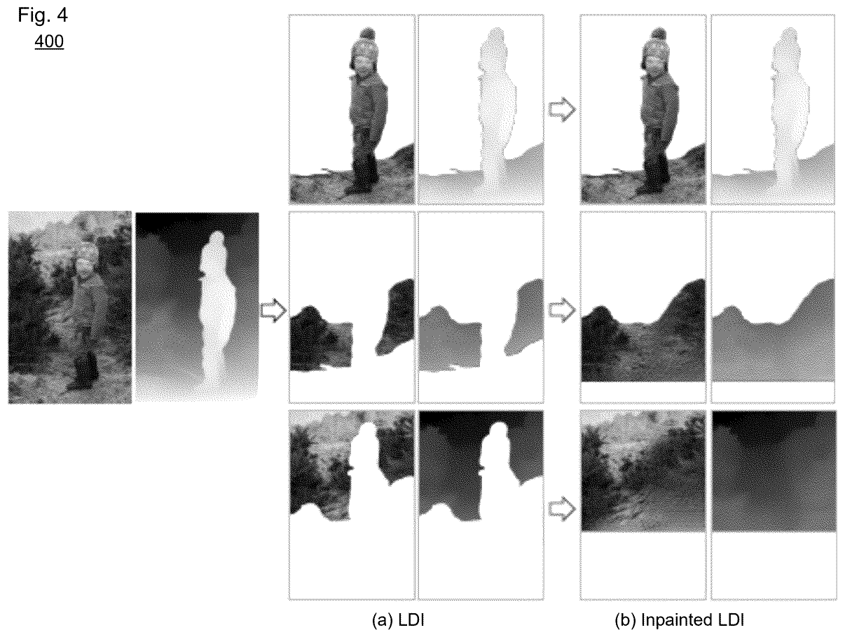

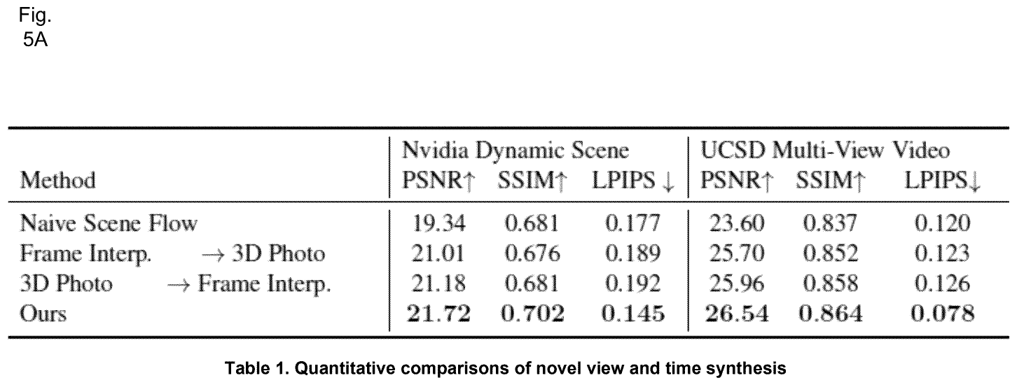

Prior methods for 3D photos may iterate over all depth edges in an LDI to adaptively inpaint local regions using background pixels of the edge. However, it has been found that this procedure is computationally expensive and the output difficult to feed into a training pipeline. A two-layer approach could be employed but is restricted in the number of layers. Given these deficiencies, an aspect of the technology employs a simple, yet effective strategy for creating and inpainting LDIs that flow well into the learning-based pipeline. Specifically, the system first performs agglomerative clustering in disparity space to separate the depth and RGB into different RGBD layers. An example of this is explained by Oded Maimon and Lior Rokach in “Data Mining And Knowledge Discovery Handbook”, 2005, the entire disclosure of which is incorporated herein by reference. This is shown in example 400 of FIG. 4 at (a) “LDI”.

A fixed disparity threshold is set above which clusters will not be merged, resulting in about 2˜5 layers for an image. The clustering is applied to the disparities of both images to obtain their LDIs,

$${ℒ}_{0} {\{ {C}_{0}^{l} , {D}_{0}^{l} \}}_{l = 1}^{{L}_{0}} and {ℒ}_{1} {\{ {C}_{1}^{l} , {D}_{1}^{l} \}}_{l = 1}^{{L}_{1}}$$

where C^{l} and D^{l} represent the lth RGBA (where the “A” represents an amount of opacity) and depth layer respectively, and L₀ and L₁ denote the number of RGBDA layers constructed from I₀ and I₁.

Next, the system applies depth-aware inpainting to each color and depth LDI layer in occluded regions. To inpaint missing contents in layer 1, all the pixels between the (th layer and the farthest layer are treated as the context region (i.e., the region used as reference for inpainting), and exclude all irrelevant foreground pixels in layers nearer than layer l. The rest of the (th layer is set within a certain margin from existing pixels to be inpainted. The system keeps only inpainted pixels whose depths are smaller than the maximum depth of layer l so that inpainted regions do not mistakenly occlude layers farther than layer l. The system may adopt a pre-trained inpainting network to inpaint color and depth at each layer, as described by Shih et al., in “3d photography using context-aware layered depth inpainting”, in CVPR, pages 8028-8038, 2020, the entire disclosure of which is incorporated herein by reference.

FIG. 4 at (b) shows an example of LDI layers after inpainting. Note that one scenario chooses to inpaint the two LDIs up front rather than performing per-frame inpainting for each rendered novel view, as the latter approach can suffer from multi-view inconsistency stemming from the lack of a consistent global representation for disoccluded regions.

### Spacetime Scene Representation

At this point the system now has inpainted color LDIs L0 and L1 for novel view synthesis. From each individual LDI, the system could synthesize new views of the static scene. However, the LDIs alone do not model the scene motion between the two photos. To enable motion interpolation, the system estimates 3D motion fields between the images. To do so, the system may first compute 2D optical flow between the two aligned images and performs a forward and backward consistency check to identify pixels with mutual correspondences. Given 2D mutual correspondences, the system uses their associated depth values to compute their 3D locations and lift the 2D flow to 3D scene flow, i.e., 3D translation vectors that displace each 3D point from one time to another. This process gives the scene flow for mutually visible pixels of the LDIs.

However, for pixels that do not have mutual correspondences, such as those occluded in the other view or those in the inpainted region, 3D correspondences are not well defined. To handle this issue, the system can leverage the fact that the scene flows are spatially smooth and propagate them from well-defined pixels to missing regions. In particular, for each pixel in I₀ with a corresponding point in L₁, the system can store its associated scene flow at its pixel location, resulting in scene flow layers initially containing only well-defined values for mutually visible pixels. To inpaint the remaining scene flow, the system can perform a diffusion operation that iteratively applies a masked blur filter to each scene flow layer until all pixels in L₀ have scene flow vectors. The same method to is applied to L₁ to obtain complete scene flow layers for the second LDI. As a result, the estimated scene flows will be asymmetric in the sense that they are bidirectional for mutually visible pixels, but unidirectional for other pixels.

To render an image from a novel camera viewpoint and time with the two scene-flow-augmented LDIs, one simple approach is to directly interpolate the LDI points to the target time according to their scene flow and splat RGB values to the target view. However, when using this method, it has been found that any small error in depth or scene flow can lead to noticeable artifacts. Thus, the system may therefore use machine learning to correct for such errors by training a 2D feature extraction network that takes each inpainted LDI color layer C^{l} as input and produces a corresponding 2D feature map F^{l}. These features encode local appearance of the scene and are trained to mitigate rendering artifacts introduced by inaccurate depth or scene flow and to improve overall rendering quality. This step converts the inpainted color LDIs to feature LDIs:

$${ℱ}_{0} {\{ {F}_{0}^{l} , {D}_{0}^{l} \}}_{l = 1}^{{L}_{0}} , {ℱ}_{1} {\{ {F}_{1}^{l} , {D}_{1}^{l} \}}_{l = 1}^{{L}_{1}} ,$$

both of which are augmented with scene flows. Finally, the system lifts the feature LDIs into a pair of point clouds P₀ [symbol] {(x₀; f₀; u₀)} and P₁ [symbol] {(x₁, f₁, u₁)}, where each point is defined with 3D location X, appearance feature f, and 3D scene flow u.

### Bidirectional Splatting and Rendering

Given a pair of 3D feature point clouds P₀ and P₁, it may be beneficial to interpolate and render them to produce the image at a novel view and time t. Thus, a depth-aware bidirectional splatting technique may be employed. Here, the system first obtains the 3D location of every point (in both point clouds) at time t by displacing it according to its associated scene flow scaled by

t.x_{0→t}=x₀+tu₀,x_{1→1}=x₁+(1−t)u₁.

The displaced points and their associated features from each direction (0→tor 1→t) are then separately splatted into the target viewpoint using differentiable point-based rendering, for instance the approach described by Wiles et al. in “Synsin: End-to-end view synthesis from a single image”, CVPR, pages 7465-7475, 2020, the entire disclosure of which is incorporated herein by reference.

This results in a pair of rendered 2D feature maps F₀→t, F₁→t, and depth maps D₁→t, D₁→t. To combine the two feature maps and decode them to a final image, the system may linearly blend them based on spatial-temporal cues. Here general principles include: 1) if t is closer to 0 then F₀→t should have a higher weight, and vice versa, and 2) for a 2D pixel, if its splatted depth D₀→t from time 0 is smaller than the depth D₁→t from time 1, then F₀→t should be favored more, and vice versa. Therefore, the system can compute a weight map to linearly blend the two feature and depth maps as follows:

$${W}_{t} = \frac{( 1 - t ) \cdot exp ( - β \cdot {D}_{0 \to t} )}{( 1 - t ) \cdot exp ( - β \cdot {D}_{0 \to t} ) + t \cdot exp ( - β \cdot {D}_{1 \to t} )} \qquad ( 1 )$$

$${F}_{t} = {W}_{t} \cdot {F}_{0 \to t} + ( 1 - {W}_{t} ) \cdot {F}_{1 \to t} \qquad ( 2 )$$

$${D}_{t} = {W}_{t} \cdot {D}_{0 \to t} + ( 1 - {W}_{t} ) \cdot {D}_{1 \to t} . \qquad ( 3 )$$

Here β ∈ [symbol] is a learnable parameter that controls contributions based on relative depth. Finally, Fₜ and Dₜ are fed to a network that synthesizes the final color image.

### Training

The feature extractor, image synthesis network, and the parameter β may be trained on two video datasets to optimize the rendering quality, as described below.

### Training Datasets

To train the system, image triplets could be used with known camera parameters, where each triplet depicts a dynamic scene from a moving camera, so that the system can use two images as input and the third one (at an intermediate time and novel viewpoint) as ground truth. However, such data may be difficult to collect at scale, since it either requires capturing dynamic scenes with synchronized multi-view camera systems, or running SfM on dynamic videos shot from moving cameras. The former may require a time-consuming setup and is difficult to scale to in-the-wild scenarios, while the latter cannot guarantee the accuracy of estimated camera parameters due to moving objects and potentially insufficient motion parallax. Therefore, it has been found that existing datasets of this kind are not sufficiently large or diverse for use as training data. Instead, two sources of more accessible data can be utilized for joint training of motion interpolation and view synthesis.

The first source contains video clips with small camera motions (unknown pose). Here, it is assumed that the cameras are static and all pixel displacements are induced by scene motion. This type of data allows us to learn motion interpolation without the need for camera calibration. The second source is video clips of static scenes with known camera motion. The camera motion of static scenes can be robustly estimated using SfM and such data gives supervision for learning novel view synthesis. For the first source, Vimeo-90K may be used, which is a widely used dataset for learning frame interpolation. See, e.g., Xue et al., “Video enhancement with task-oriented flow”, IJCV, 127 (8): 1106-1125, 2019, the entire disclosure of which is incorporated herein by reference. For the second source, the Mannequin-Challenge dataset may be used, which contains over 170K video frames of humans pretending to be statues captured from moving cameras, with corresponding camera poses estimated through SfM. Here, see the example by L₁ et al., “Learning the depths of moving people by watching frozen people”, in CVPR, pages 4521-4530, 2019; see also Zhou et al., “Stereo magnification: learning view synthesis using multiplane images” in ACM TOG, 37:1-12, 2018, the entire disclosure of which are incorporated herein by reference. Since the scenes in this dataset including people are (nearly) stationary, the estimated camera parameters are sufficiently accurate. These two datasets may be mixed to train the model.

### Learnable Components

The system may include several modules, e.g., (a) monocular depth estimator, (b) color and depth inpainter, (c) 2D feature extractor, (d) optical flow estimator and (e) image synthesis network. While this whole system (a)-(e) could be trained, in some examples only (c), (d), and (e) are trained on the aforementioned data sets, using pretrained models for (a) and (b). This makes training less computationally expensive, and also avoids the need for the large-scale direct supervision required for learning high-quality depth estimation and RGBD inpainting networks.

### Training Losses

The system may be trained using image reconstruction losses. In particular, one can minimize perceptual loss and l₁ loss between the predicted and ground-truth images to supervise the networks. Here, perception loss can be minimized as described by Zhang et al. in “The unreasonable effectiveness of deep features as a perceptual metric”, in CVPR, pages 586-595, 2018, the entire disclosure of which is incorporated herein by reference.

### Experiments

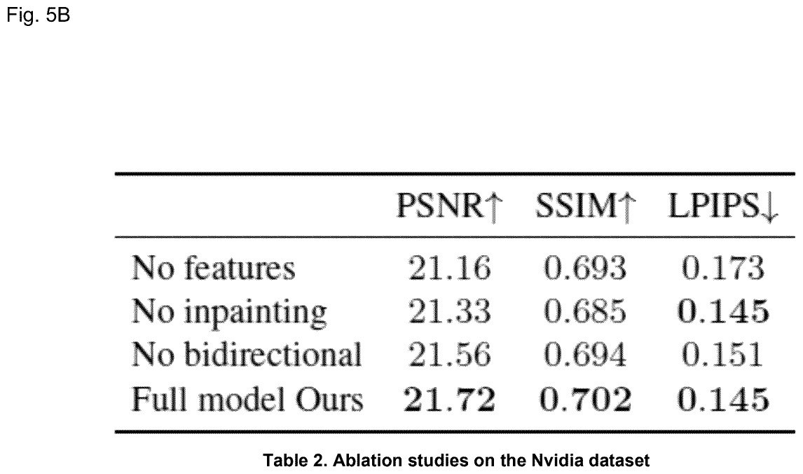

Details regarding experiments are found in the accompanying appendix. Here, section 4.1 provides implementation details, section 4.2 provides baselines, section 4.3 provides comparisons on public benchmarks, section 4.4 discusses comparisons on in-the-wild photos, and section 4.5 addresses ablation and analysis. Table 1 (FIG. 5A) presents quantitative comparisons of novel view and time synthesis, and Table 2 (FIG. 5B) presents ablation studies on the Nvidia dataset, where “Ours” includes results for the above-described technology.

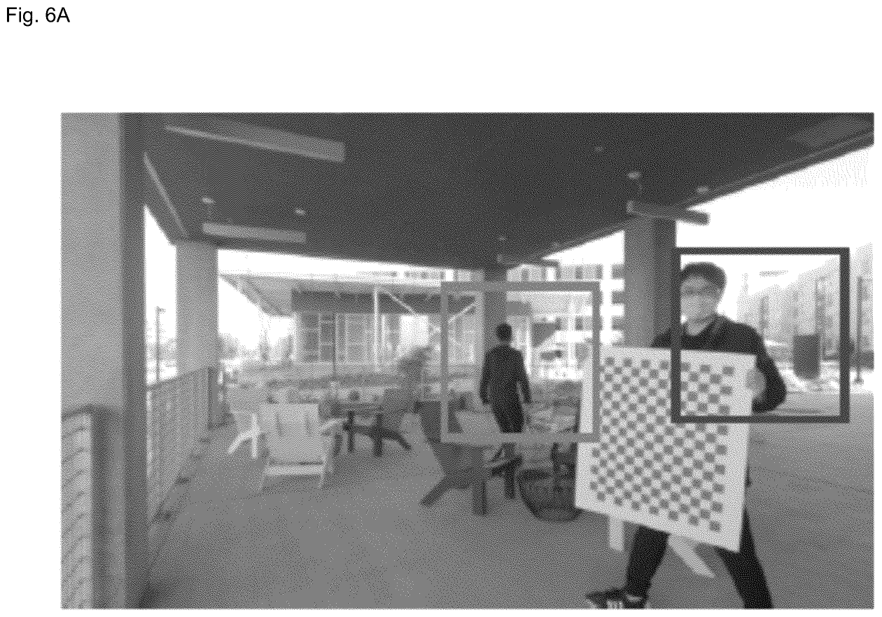

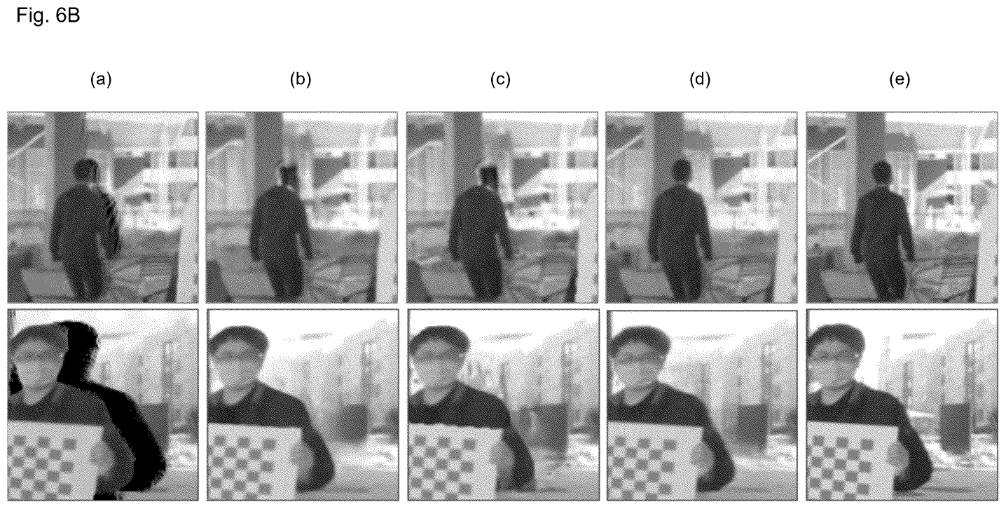

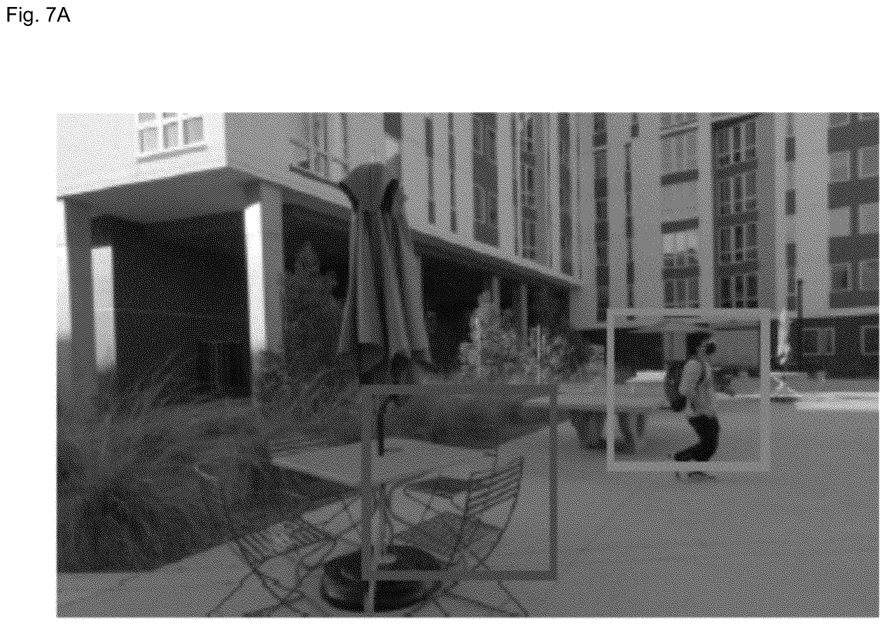

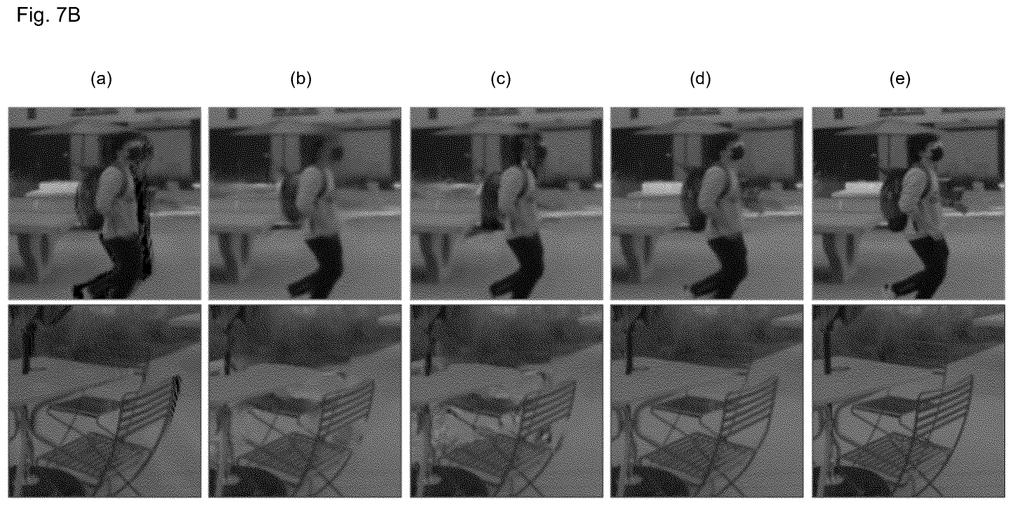

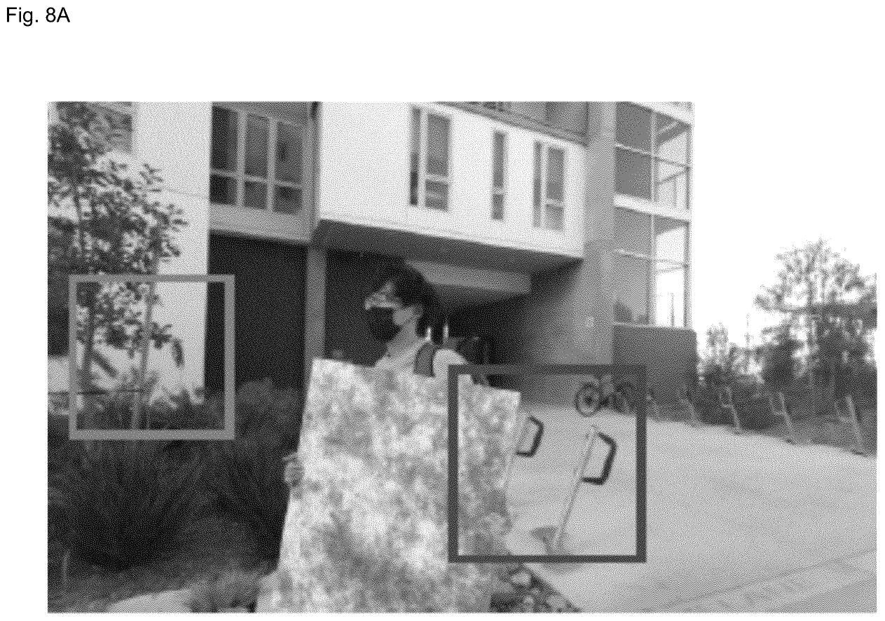

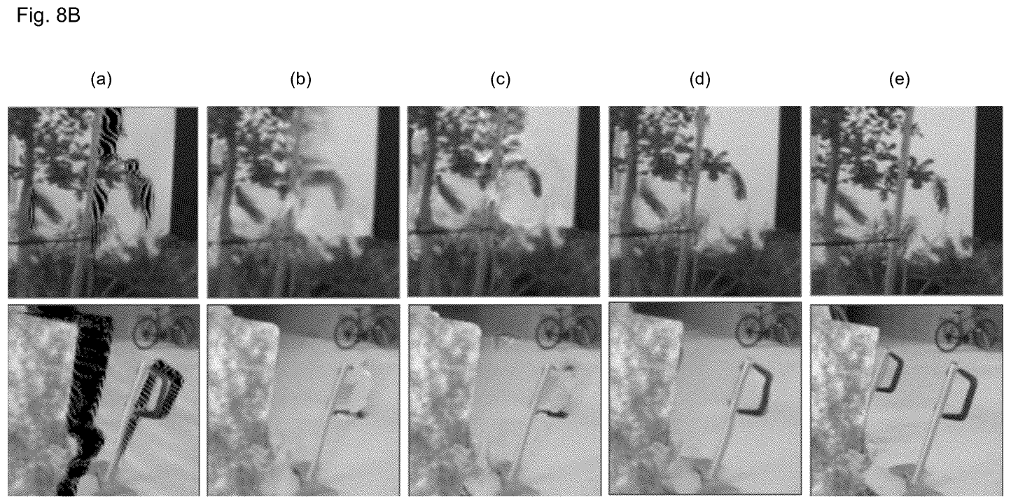

FIGS. 6A-B, 7A-B and 8A-B illustrate three qualitative comparisons on the UCSD dataset. From left to right in each of 6B, 7B and 8B are (a) naive scene flow, (b) Frame Interpolation→3D Photo, (c) 3D Photo→Frame interpolation, (d) the method according to the present technology, and (e) ground truth.

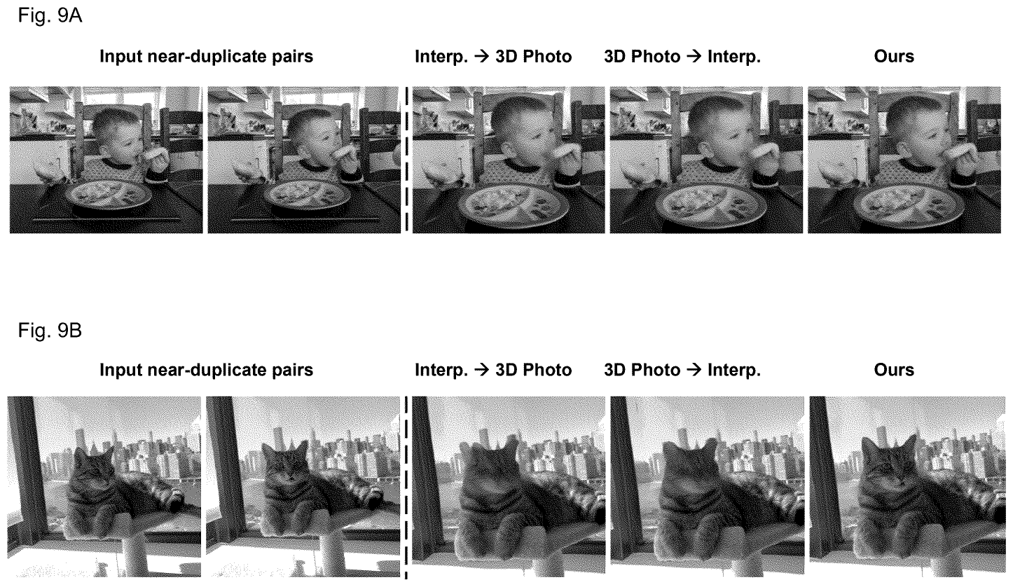

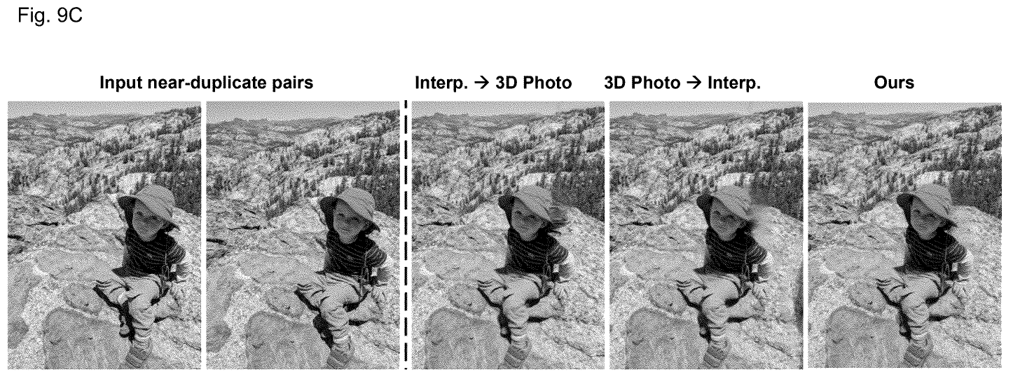

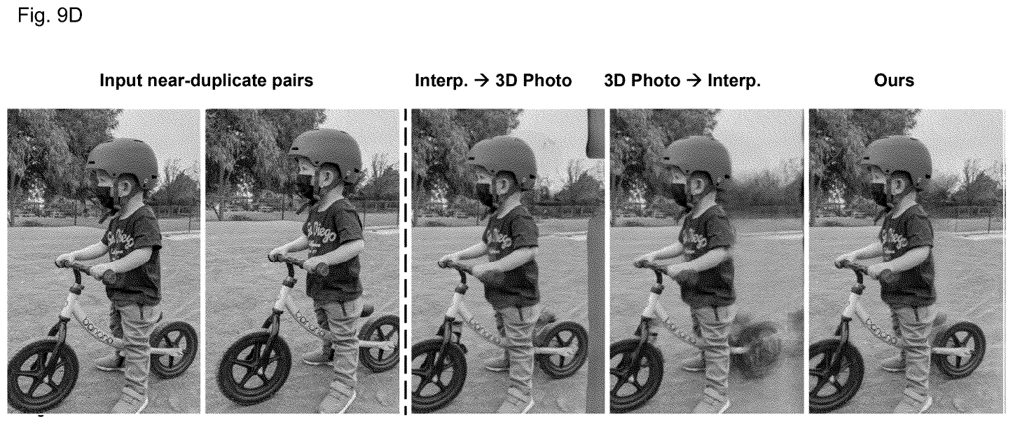

FIGS. 9A-D illustrate qualitative comparison examples on in-the-wild photos. The two leftmost images in each of these figures are the input near-duplicate pairs. The next (middle) image is an Interpolation→3D Photo, followed by an image for 3D Photo→interpolation, and the rightmost image is the output generated by the present technology. As seen in these examples, compared with the baselines, the approach disclosed herein produces more realistic views with significantly fewer visual artifacts, especially in moving or disoccluded regions.

### Example Computing Architecture

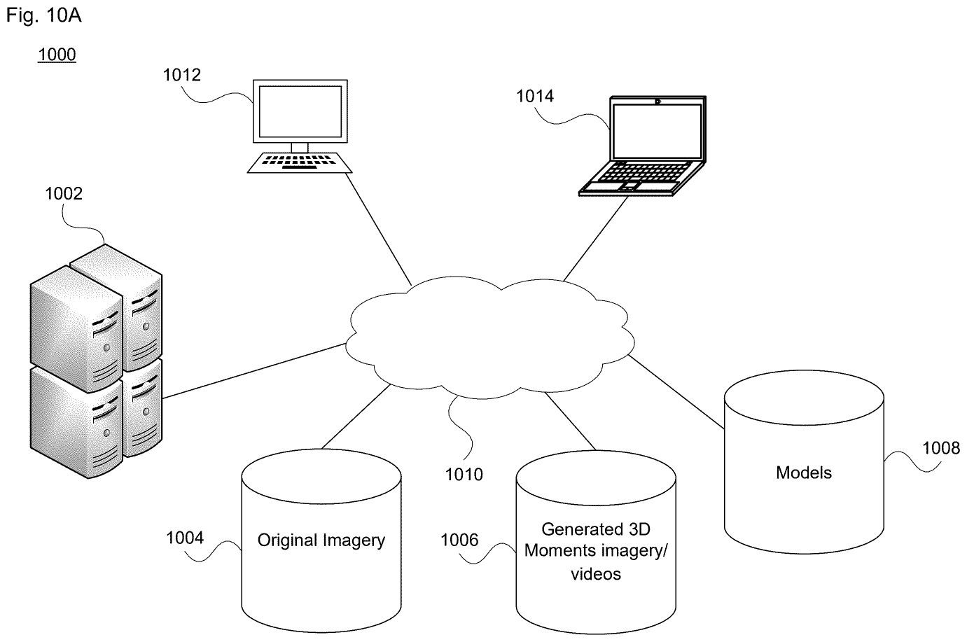

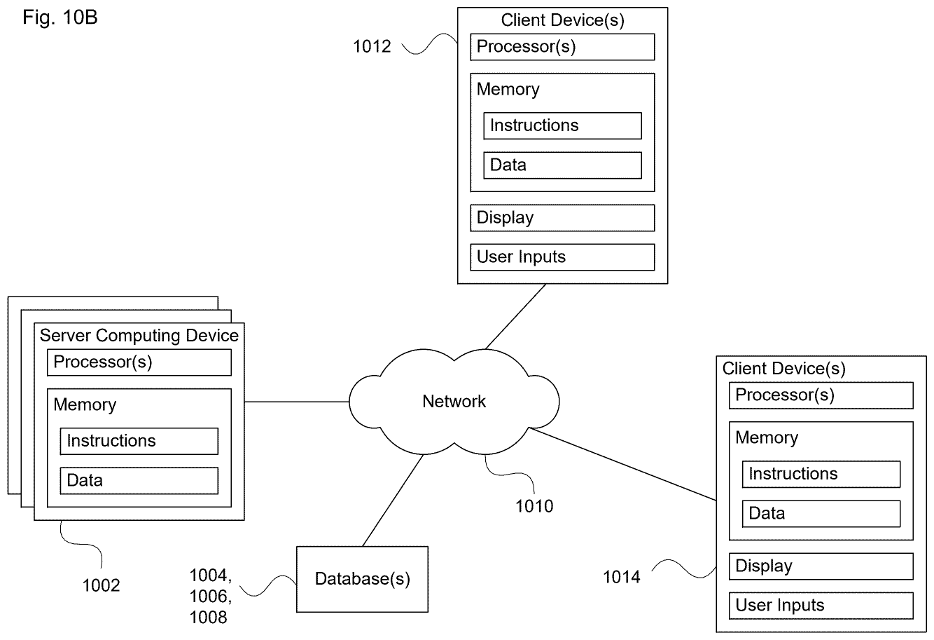

The models described herein may be trained on one or more tensor processing units (TPUs), CPUs or other computing architectures in order to implement 3D Moments in accordance with the features disclosed herein. One example computing architecture is shown in FIGS. 10A and 10B. In particular, FIGS. 10A and 10B are pictorial and functional diagrams, respectively, of an example system 1000 that includes a plurality of computing devices and databases connected via a network. For instance, computing device(s) 1002 may be a cloud-based server system. Databases 1004, 1006 and 1008 may store, e.g., the original imagery, generated 3D Moments imagery/videos, and/or trained models respectively. The server system may access the databases via network 1010. Client devices may include one or more of a desktop computer 1012 and a laptop or tablet PC 1014, for instance to provide the original imagery and/or to view the output visualizations (e.g., generated videos or use of such videos in a video service, app or other program).

As shown in FIG. 10B, each of the computing devices 1002 and 1012-1014 may include one or more processors, memory, data and instructions. The memory stores information accessible by the one or more processors, including instructions and data (e.g., models) that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs, TPUs, graphical processing units (GPUs), etc. Alternatively, each processor may be a dedicated device such as an ASIC or other hardware-based processor. Although FIG. 10B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 1002. Accordingly, references to a processor or computing device will be understood to include references to a collection of processors or computing devices or memories that may or may not operate in parallel.

Input data, such as one or more image pairs, may be operated on by the modules and processes described herein. The client devices may utilize such information in various apps or other programs to perform quality assessment or other metric analysis, recommendations, image or video classification, image or video search, etc. Other ways the technology can be employed is on consumer photography platforms that may store sets of user imagery, and professional editing tools that enable a user to manipulate their photos. In the former case it may make sense to rely on automatically creating these effects for the user by the app or service, whereas in the latter case on-demand generation of such effects may be more appropriate.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices (e.g., a monitor having a screen or any other electrical device that is operable to display information (e.g., text, imagery and/or other graphical elements). Other output devices, such as speaker(s) may also provide information to users.

The user-related computing devices (e.g., 1012-1014) may communicate with a back-end computing system (e.g., server 1002) via one or more networks, such as network 1010. The network 1010, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 1002 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 1002 may include one or more server computing devices that are capable of communicating with any of the computing devices 1012-1014 via the network 1010.

Input imagery, generated videos and/or trained ML models may be shared by the server with one or more of the client computing devices. Alternatively or additionally, the client device(s) may maintain their own databases.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A method for processing still images, the method comprising:
aligning, by one or more processors, a pair of still images in a single reference frame;
transforming, by the one or more processors, the pair of still images into color layered depth images (LDIs) with inpainted color and depth in occluded regions;
extracting, by the one or more processors, deep feature maps from each color layer of the LDIs to obtain a pair of feature LDIs;
estimating, by the one or more processors, scene flow of each pixel in the feature LDIs based on predicted depth and optical flows between the pair of still images;
lifting, by the one or more processors, the feature LDIs into a pair of point clouds; and
combining, by the one or more processors, features of the pair of point clouds bidirectionally to synthesize one or more final images.

2. The method of claim 1, wherein:
a first one of the pair of still images is associated with a first time to;
a second one of the pair of still images is associated with a second time t₁ different from t₀; and
the synthesized one or more final images include at least one image associated with a time t′ occurring between to and t₁.

3. The method of claim 1, wherein aligning the pair of still images in a single reference frame is performed via a homography.

4. The method of claim 3, wherein aligning further includes computing a dense depth map for each of the pair of images.

5. The method of claim 1, wherein each pixel in the pair of feature LDIs is composed of a depth, a scene flow, and a learnable feature.

6. The method of claim 1, wherein the extracting the deep feature maps to obtain the pair of feature LDIs includes applying a 2D feature extractor to each color layer of the LDIs to obtain feature layers in which colors in the LDIs are replaced with features.

7. The method of claim 1, wherein combining the features of the pair of point clouds bidirectionally to synthesize the one or more final images includes projecting and splatting feature points from the pair of point clouds into forward and backward feature maps and corresponding projected depth maps.

8. The method of claim 7, wherein the forward feature map is associated with a first one of the pair of point clouds corresponding to a first one of the pair of still images, and the backward feature map is associated with a second one of the pair of point clouds associated with a second one of the pair of still images.

9. The method of claim 7, wherein at least one of the (i) forward and backward feature maps or (ii) the corresponding depth maps are linearly blended according to a weight map derived from a set of spatio-temporal cues.

10. The method of claim 1, further comprising masking out regions having optical flows exceeding a threshold.

11. The method of claim 1, wherein transforming the pair of still images into the color layered depth images (LDIs) with inpainted color and depth in occluded regions comprises:
performing agglomerative clustering in a disparity space to separate depth and colors into different layers; and
applying depth-aware inpainting to each color and depth layer in occluded regions.

12. The method of claim 11, further comprising discarding any inpainted pixels whose depths are larger than a maximum depth of a selected depth layer.

13. The method of claim 1, wherein estimating the scene flow includes computing the optical flows between the aligned pair of still images and performing a forward and backward consistency check to identify pixels with mutual correspondences between the aligned pair of still images.

14. An image processing system, comprising:
memory configured to store imagery; and
one or more processors operatively coupled to the memory, the one or more processors being configured to:
align a pair of still images in a single reference frame;
transform the pair of still images into color layered depth images (LDIs) with inpainted color and depth in occluded regions;
extract deep feature maps from each color layer of the LDIs to obtain a pair of feature LDIs;
estimate scene flow of each pixel in the feature LDIs based on predicted depth and optical flows between the pair of still images;
lift the feature LDIs into a pair of point clouds; and
combine features of the pair of point clouds bidirectionally to synthesize one or more final images.

15. The image processing system of claim 14, wherein alignment of the pair of still images in a single reference frame is performed via a homography.

16. The image processing system of claim 14, wherein alignment further includes computation of a dense depth map for each of the pair of images.

17. The image processing system of claim 14, wherein extraction of the deep feature maps to obtain the pair of feature LDIs includes application of a 2D feature extractor to each color layer of the LDIs to obtain feature layers in which colors in the LDIs are replaced with features.

18. The image processing system of claim 14, wherein combination of the features of the pair of point clouds bidirectionally to synthesize the one or more final images includes projection and splatting of feature points from the pair of point clouds into forward and backward feature maps and corresponding projected depth maps.

19. The image processing system of claim 14, wherein the one or more processors are further configured to mask out regions having optical flows exceeding a threshold.

20. The image processing system of claim 14, wherein the one or more processors are configured to transform the pair of still images into the color layered depth images (LDIs) with inpainted color and depth in occluded regions by:
performance of agglomerative clustering in a disparity space to separate depth and colors into different layers; and
application of depth-aware inpainting to each color and depth layer in occluded regions.

21. The image processing system of claim 14, wherein the one or more processors are further configured to discard any inpainted pixels whose depths are larger than a maximum depth of a selected depth layer.

22. The image processing system of claim 14, wherein estimation of the scene flow includes computation of the optical flows between the aligned pair of still images and performance of a forward and backward consistency check to identify pixels with mutual correspondences between the aligned pair of still images.
